(19) United States
(12) Patent Application Publication
(10) Pub. No.: US 2011/0148956 A1
(43) Pub. Date: Jun. 23, 2011

(54) INKJET RECORDING APPARATUS

(75) Inventor: Nobuhiko Nakahara, Shizuoka-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 12/960,815

(22) Filed: Dec. 6, 2010

Related U.S. Application Data
(60) Provisional application No. 61/288,636, filed on Dec. 21, 2009.

(30) Foreign Application Priority Data
Jul. 30, 2010 (JP) 2010-173046

(51) Int. Cl. B41J 29/38

(52) U.S. Cl. 347/2; 347/9

(57) ABSTRACT

An inkjet recording apparatus comprising; a recording portion for recording an image on a recording medium, said recording portion having an inkjet head unit including a plurality of connected line heads, an acquisition portion for acquisitioning pixel information indicated by a pixel of a document, a memory portion for storing position information of a joint portion of said head unit and head property information, a prediction portion for seeking output property by each printing directions based on said pixel information, said position information and said head property information, a direction conversion portion for converting a printing direction to reduce influence of the joint portion of said head unit on the document based on the output property acquired by said acquisition portion and said direct conversion output to said recording portion.

### CROSS-REFERENCE TO RELATED APPLICATIONS

The application is based upon and claims the benefit of priority from U.S. Provisional Application No. 61/288,636, filed Dec. 21, 2009, which is hereby incorporated by reference.

The application is based upon and claims the benefit of priority from Japanese Application No. P2010-173046, filed Jul. 30, 2010, which is hereby incorporated by reference.

### TECHNICAL FIELD

Embodiments described herein relate generally to an inkjet recording apparatus.

### BACKGROUND

In recent years, in order to achieve high printing/recording speed, a line-head is structured by connecting a plurality of inkjet heads, and in such a manner a recording apparatus, which records an image on a recording material with one scan path or less scan paths, is launched in a market.

Due to an error of recording accuracy relating to an ink ejecting property of each nozzle, such a recording apparatus corrects recording uneven of each ink-nozzle by carrying a complex multi-scan etc. Further, when a plurality of inkjet heads is connected, white lines, black lines or multileveled density and so on appears at the portion of this connection because of unevenness relating to fixing position accuracy between heads, unevenness relating to a property between each head and a difference of an ejecting property of a head end itself.

Consequently, this appearance visually presents uncomfortable as line-like noise. Hitherto, a process such that these line heads execute said complex multi-scan etc in order to reduce line-like noise, is proposed. Additionally, another process is proposed. In such process, displacing divisional points of multi-heads by a position of sub-scan direction by slow degree can reduce the line-like noise.

### SUMMARY

However, the method of conducting the above mentioned mufti-scan etc provides the issue of slow printing speed. In addition, it is not easily achieved that the divisional positions are delicately adjusted in regards to the method of displacing divisional head positions

It is an objet of the embodiment to provided that an inkjet recording apparatus, which can reduce a visual noise appearance without a delicate head adjusting, or a multi-scan in order to prevent line-like noise from appearing at the joint portion of multi-head.

According to one aspect of the embodiment, there is provided that an inkjet recording apparatus comprising; a recording portion for recording an image on a recording medium, said recording portion having an inkjet head unit including a plurality of connected line heads, an acquisition portion for acquisitioning pixel information indicated by a pixel of a document, a memory portion for storing position information of a joint portion of said head unit and head property information, a prediction portion for seeking output property by each printing directions based on said pixel information, said position information and said head property information, a direction conversion portion for converting a printing direction to reduce influence of the joint portion of said head unit on a document based on the output property acquired by said acquisition portion and said direct conversion output to said recording portion.

### BRIEF DESCRIPTION OF THE DRAWINGS

FIG. 1 is a block diagram showing a configuration of an inkjet recording apparatus according to one embodiment of the invention.

FIG. 2 is a conception drawing showing one example of the nozzle status of a recording apparatus.

FIG. 3 is a flowchart showing an operation of a recording apparatus shown in FIG. 1.

FIG. 4 is a drawing showing the relation between a printing direction and a layout.

FIG. 5 is a drawing showing the relation between a printing direction and a layout.

FIG. 6 is a drawing showing the relation between a printing direction and a layout.

FIG. 7 is a drawing showing the relation between a printing direction and a layout.

FIG. 8 is a drawing showing the relation between a printing direction and a distribution of chromaticity.

FIG. 9 is a drawing showing the relation between a printing direction and a distribution of chromaticity.

FIG. 10 is a drawing showing the relation between a printing direction and a distribution of chromaticity.

FIG. 11 is a drawing showing the relation between a printing direction and a distribution of chromaticity.

FIG. 12 is a drawing explaining the calculation of an average chromaticity of blocks.

FIG. 13 is a drawing showing a visual color discrimination ellipse.

### DETAILED DESCRIPTION

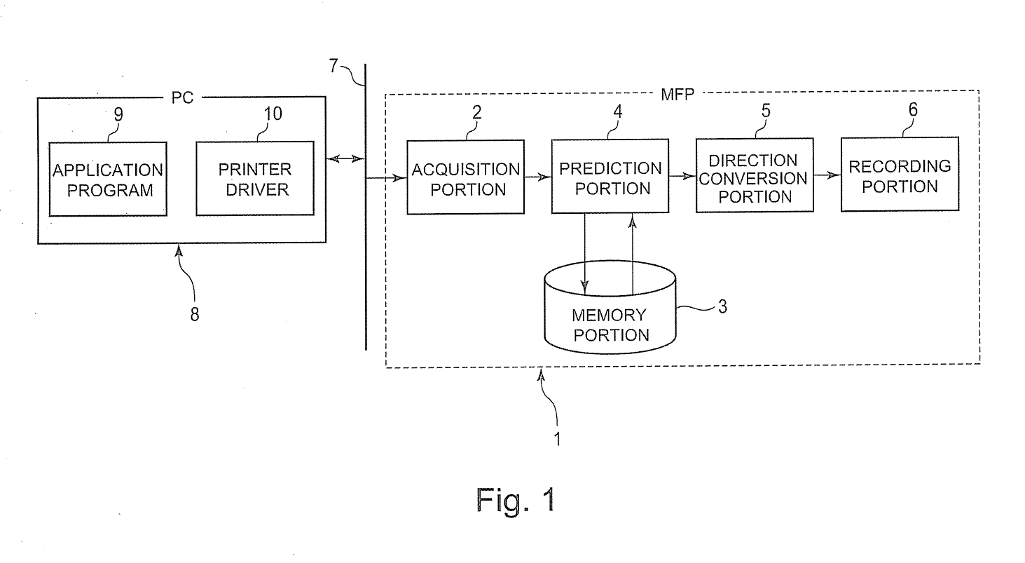

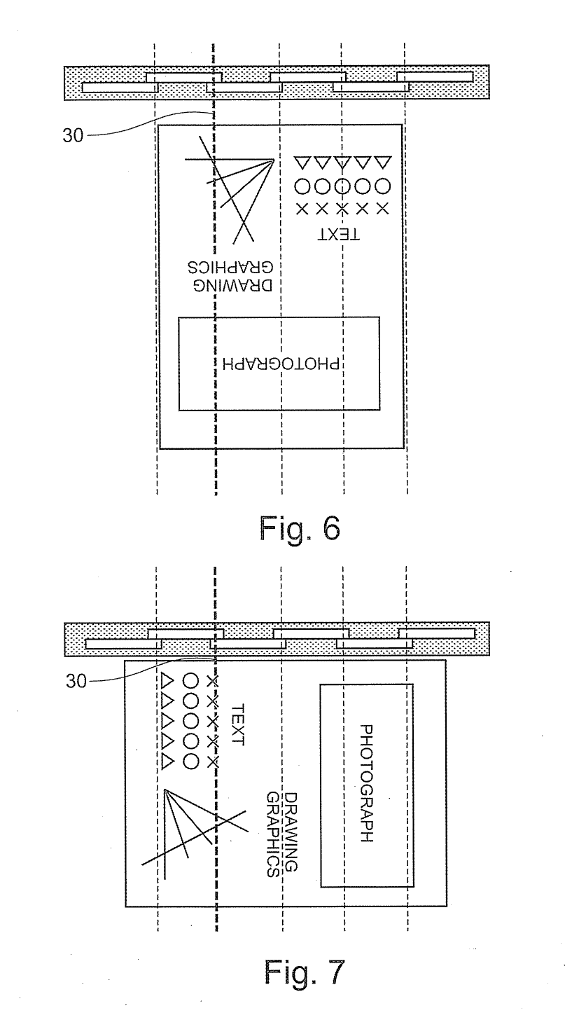

Hereinafter, embodiments regarding the invention will be described with reference to FIG. 1-13.

FIG. 1 is an overall drawing showing an embodiment of a multi functional printer (hereinafter MFP) applied by this invention. This MFP 1 comprises an acquisition portion 2 for acquisitioning pixel values, a memory portion 3 for storing position information regarding joint portions of head units and head property information regarding heads, a prediction portion 4 for seeking an output property of a printing material from said pixel value, the position information and the head property information, a direction conversion portion 5 for converting image to the suitable direction based on the result sought by said prediction portion 4 and a recording portion 6 having an inkjet head unit for ejecting an ink on a recording medium such as a paper based on a document or image data.

And the MFP 1 connects to a terminal such as a personal computer (hereinafter PC) 8 via a network 7. An applications program 9 such as a word processing or paint software and a printer driver 10 giving a printing order to the MFP 1 are installed into the PC 8.

When a user instructs a printing operating regarding an image or a document produced/edited on the PC 8 via the printer driver 10 at this time, a printing data is transmitted to the MFP 1, in case of necessity the direction of image is converted, a hard copy is produced by inkjet head units of the recording portion 6.

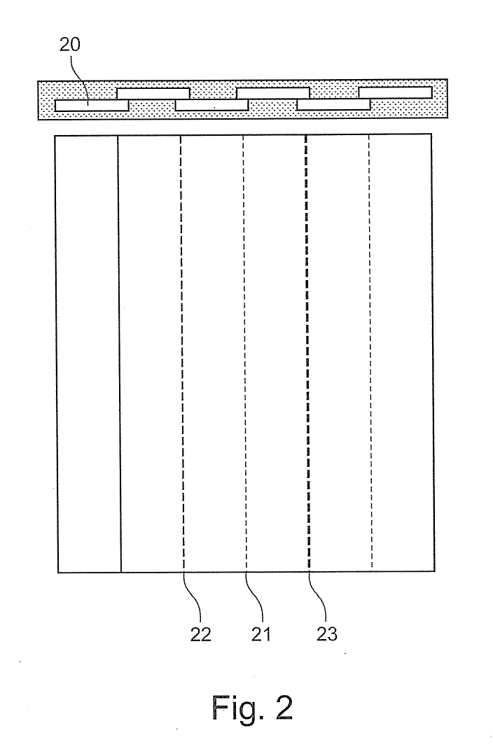

FIG. 2 is a rough drawing showing a configuration of this inkjet head unit. A plurality of heads is disposed and connected as zigzag-like as showed in this drawing, because it is difficult to produce a long head for an inkjet printer. If the property of this head is always consistency, there is no problem.

However, it has limitations to keep consistency, considering a cost or a yield ratio. Accordingly, it is popular to dispose and connect heads with each other, which have some variability.

Heads 20 are connected in order to adjust the heads which has a smaller difference among the heads for preventing from arising a noise at a central joint portion where it is easier found. Nevertheless, it is difficult to adjust heads at a connecting portion far from a center, so it is generated that a portion having a large difference.

For example, unevenness is not almost appearing at a central joint portion 21 as shown in this drawing, however a bigger line-like noise is appearing at a portion 22 far from a central portion and the biggest line-like noise is appearing at a portion 23. As well, although suppressing color unevenness at the central portion, it is highly possible that bigger color unevenness appears at a joint portion far from the central portion.

Line-like noise is highly visible at this unevenness joint portion; especially it is very obtrusive that this line-like noise appears at the area, where a pixel value such as a photograph or an image is uniform and intermediate. On the contrary, it is not obtrusive that this line-like noise even appears at the area, where a pixel value such as a text image or a graphical image is not uniform and intermediate.

Thus, in this embodiment, a direction conversion of the image is intended so that this line-like noise is allocated at the portion where such noise is not easily visible on a display. Further, in regards to color unevenness, white or solid color portion is allocated at bigger color unevenness. In case of difficulty of allocating white or solid color portion, it is desirable that uneasily visible color in terms of color unevenness should be allocated.

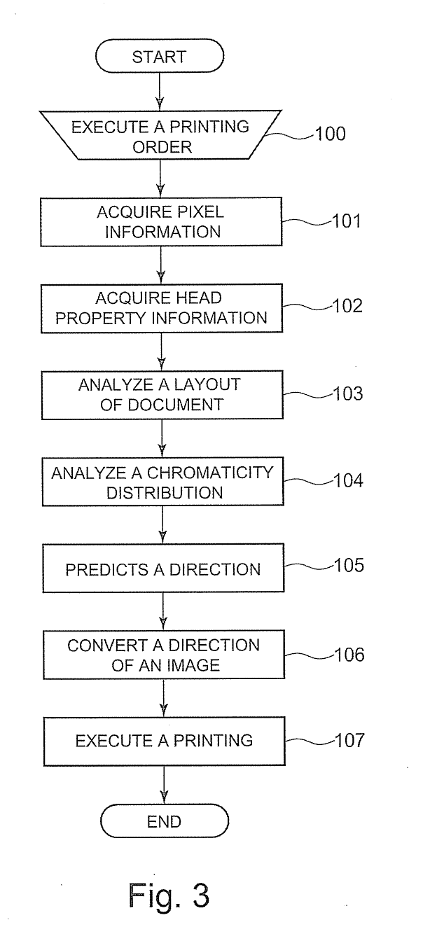

An embodiment applying the invention will be explained in the following FIG. 3 as a flowchart, to achieve this, when an executing order is given by the PC 8 as shown in FIG. 1.

A printing order is executed on the PC 8 (100), then the acquisition portion 2 acquires pixel information including a layout of a document via PC 8 (101) for instance. Then, the prediction portion 4 acquires this pixel information from the acquisition portion 2, said prediction portion further acquires head property information and joint position information of the head unit stored in the memory portion 3 (102). Said pixel information may contain the chromaticity distribution.

Next, the prediction portion 4 analyzes the layout based on the pixel information acquired by the above-mentioned process (103), further analyzes chromaticity distribution information (104). The prediction portion 4 seeks the output property of said printing material based on the joint position information of the head unit and head property information.

From the output property based on the layout, the chromaticity distribution information and the head property information, the prediction portion 4 predicts the direction where line-like noise is not easily noticed for printing (105). According this prediction, the direction conversion portion 5 coverts the image direction to the suitable direction (106) and the recording portion 6 executes the printing operation (107). Output property of said printing material is the pixel value on the joint position of said head units at output.

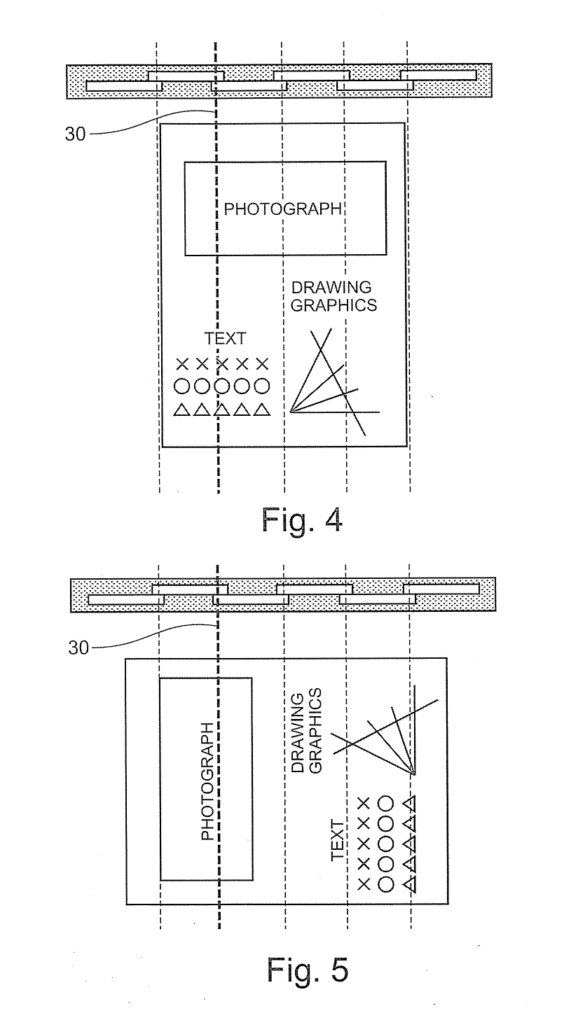

Next, the determination of the direction for printing will be explained. First, the direction, where line-like noise is not easily visual is determined as follows. FIGS. 4-7 are pattern diagrams which show that the direction of the image for printing is converted by 90 degree each by each. In this figure, a bold dot portion 30 is the area which is passed by the joint portion, which is easily noticed as line-like noise.

Compared to these ones, in FIG. 4-6, a path is just crossing the photographical area where it is easily noticed as line-like noise. Thus, it is highly possible that line-like noise is obtrusive. On the other hand, in FIG. 7, the path of the joint portion is on a text or a graphics area where it is not relatively easily noticed. Therefore, this direction is a most suitable way.

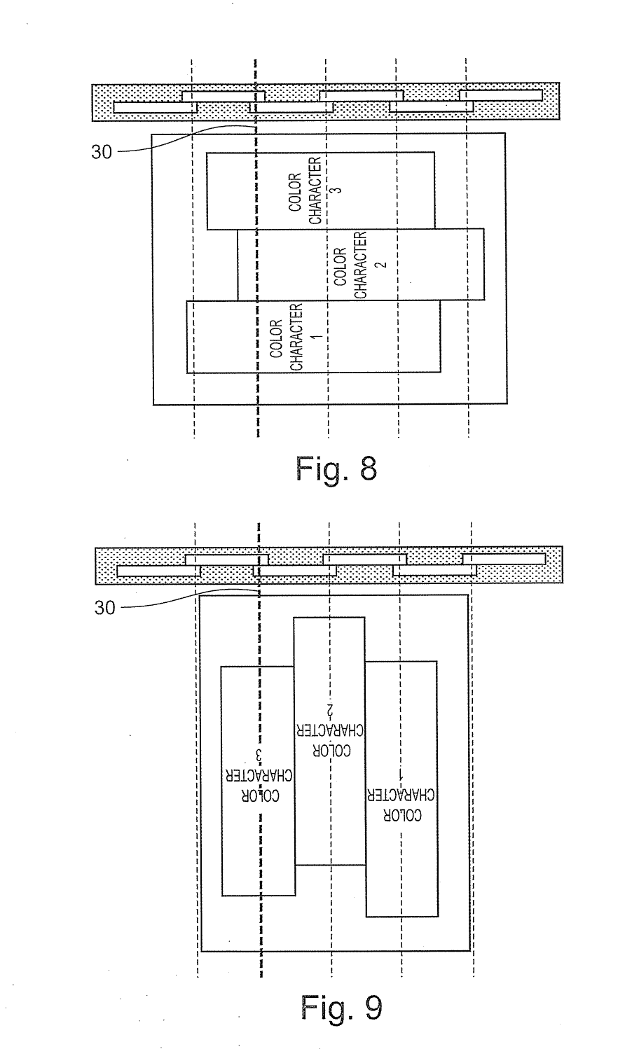

In addition, the chromaticity distribution of an image for printing is used as reference at the time when the printing direction is determined. FIG. 8-11 are pattern diagrams, which shows that the direction of the image for printing is converted by 90 degree as well as FIG. 4-7. The objective image is the image, which contains three types of a color region as shown in this figure for instance. Each color region may be a color bar or a gradation pattern, and the types of color region of a text or a photograph etc, are same. At the above mentioned case, it is assumed that unevenness of a line-head for use is the biggest at the joint portion 30.

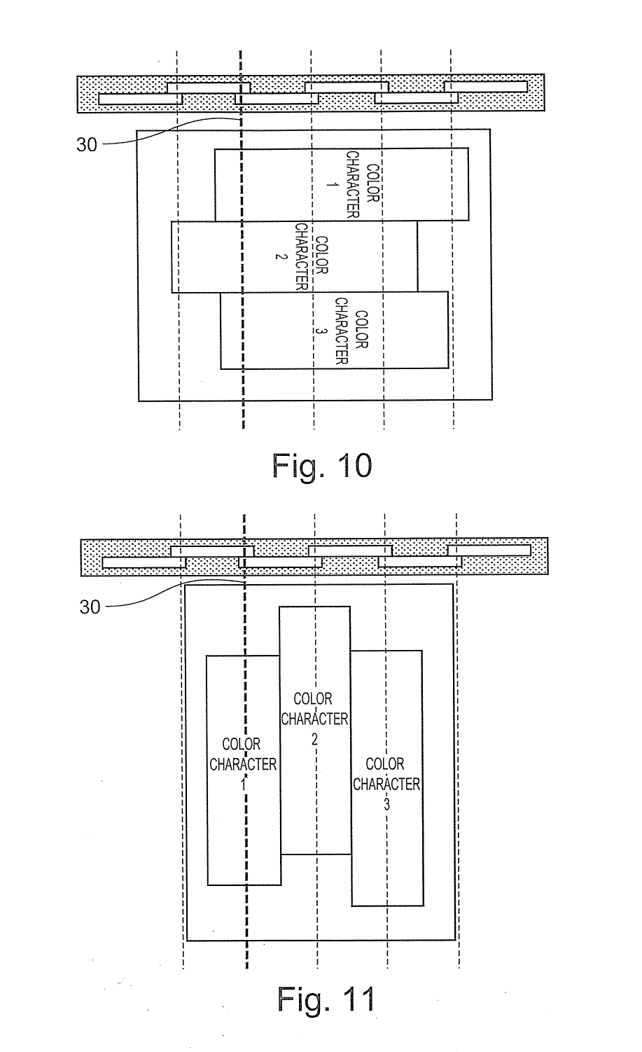

Here, a path passed by the joint portion, which causes big color unevenness, is crossing over all color regions along the direction as shown in FIG. 8 and FIG. 10. In contrast, the joint portion is crossing over only one color region along the direction as shown in FIG. 9 and FIG. 11.

Accordingly, it is desirable that the direction among the directions of FIG. 9-11 should be selected so that an objective color region becomes the region where color discrimination capability is low.

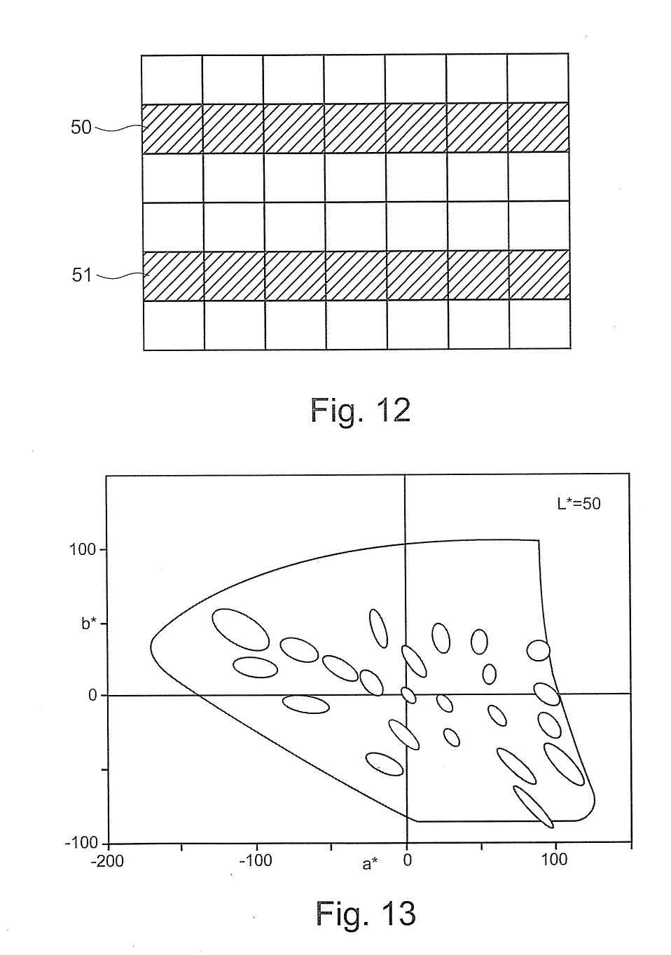

Color discrimination capability of one region is determined by the following process. As shown in FIG. 12, by dividing an image into a plurality of block lengthwise and crosswise, an average chromaticity in the block is sought. Further, as shown in this figure, the aggregate blocks where the joint portion, which causes big color unevenness, is crossing over, is determined. Next, the average color chromaticity of the aggregate blocks, in another word, a region 50 and a region 51 hatched in this figure, is sought individually.

And it is sought that the value which corresponds to color discrimination capability referred to the following chromaticity stored in the memory portion 3 as address. In another word, since the color discrimination capability means a size of color discrimination circle, the value corresponds to the size from a table is sought. The value is regarded as reference for color discrimination capability of the region.

FIG. 13 shows a human visual color discrimination capability ellipse. The size of this ellipse is stored in memory portion 3 by each chromaticity. The average value of chromaticity of the region sought by the above-mentioned operation selects the closest discrimination circle shown in a chromaticity diagram as the represent color discrimination capability circle of the region

Here, it is preferable to select the direction for the printing direction, along which a path is crossing over the area, where the color discrimination capability is low, that is, a big size of color discrimination capability circle is large. Details of color discrimination are described in “New edition color science handbook (2nd edition) pp. 126-127 TOKYO UNIVERSITY PUBLICATION COMPANY. Contents of which are hereby incorporated by reference.

As above mentioned, when the direction selected in terms of line-like noise or chromaticity unevenness is same, such direction is selected as a printing direction. In contrast, when unmatched, the printing direction is finally determined so that the direction, which is not easily noticed visually, has the priority. In addition, when the direction for smaller line-line noise or color chromaticity is two or more directions, it is preferable to select the direction, which makes short for sub-scan direction.

While certain embodiments have been described, these embodiments have been presented by way of example only, and are not intended to limit the scope of the inventions. Indeed, the novel methods and systems described herein may be embodied in a variety of the other forms; furthermore, various omissions, substitutions and changes in the form the methods and systems described herein may be made without departing from the sprit of the inventions. The accompanying claims and their equivalents are intended to cover such forms or modifications as would fall within the scope and spirit of the inventions.

What is claim is:

1. An inkjet recording apparatus comprising:
a recording element configured to record an image on a recording medium, said recording element having an inkjet head unit including a plurality line head connected each other;
an acquisition element configured to acquire pixel information indicated by a pixel of a document;
a memory element configured to store position information of a joint portion of said head unit and head property information;
a prediction element configured to seek output property of each printing directions, based on the pixel information, the position information and the head property information; and
a direction conversion element configured to convert a printing direction to reduce influence of the joint portion of said head unit on the document based on the output property acquired by said acquisition element and said direct conversion outputting to said recording element.

2. The inkjet recording apparatus as set forth in claim 1:
wherein the pixel information includes layout information of the document.

3. The inkjet recording apparatus as set forth in claim 1:
wherein said memory element stores color discrimination capability regarding chromaticity and peripheral chromaticity, and the pixel information acquired by said acquisition element includes chromaticity distribution information.

4. The inkjet recording apparatus of claim 1:
wherein the output property sought by said prediction element is a pixel value on the joint portion of said head unit at output.

5. A recording apparatus comprising:
a recorder which records an image on a recording medium along a direction and said recorder possessing recorder property;
an acquisition portion which acquires pixel information of the image to be recorded by said recorder;
a prediction portion which seeks output property in term of the direction, based on the pixel information and the recorder property; and
a direction converter which converts the direction for recording based on the output property predicted by said prediction portion.

6. A recording apparatus as set forth in claim 5:
wherein said recorder further comprises a plurality of inkjet head, ejecting ink on the recording medium, said inkjet heads jointed each other as a line inkjet head unit for recording along the direction.

7. A recording apparatus as set forth in claim 6 further comprising:
a memory which stores the recorder property possessed by said recorder;
wherein said recorder property, stored in said memory, includes at least one of position property relating to a jointing position jointed the inkjet heads and head property relating to the line inkjet head unit.

8. A recording apparatus as set forth in claim 7:
wherein said prediction portion seeks the output property including at least one the position property, the head property and the pixel information.

9. A recording apparatus as set forth in claim 7:
wherein said position property relates to the jointing position which causes the biggest color unevenness, and said direction converter converts the direction for recording based on the jointing position which causes the biggest color unevenness.

10. A recording apparatus as set forth in claim 9:
wherein said jointing position, which causes the biggest color unevenness, of the inkjet heads is not located at center of the line inkjet head.

11. A recording apparatus as set forth in claim 7:
wherein said pixel information includes layout information regarding image to be recorded, said layout information includes an area information to be recorded, which is text or photograph.

12. A recording apparatus as set forth in claim 11:
wherein said direct converter converts the direction for recording so that the jointing position which causes the biggest color unevenness is not crossing over the area to be recorded as photograph.

13. A recording apparatus as set forth in claim 9:
wherein said pixel information includes chromaticity distribution of the image to be recorded, and said direct converter converts the direction for recording so that the jointing position which causes the biggest color unevenness crosses over an area which has less chromaticity distribution.

14. A recording apparatus as set forth in claim 9:
wherein said memory stores color discrimination capability regarding chromaticity and peripheral chromaticity, and the pixel information acquired by said acquisition portion includes chromaticity distribution information.

15. An image forming method for forming an image on a medium along a direction scanned by a line head unit comprising:
acquiring pixel information of the image to be formed and image forming property relating to the line head unit;
predicting the direction where line-like noise is not easily noticed based on the pixel information and the image forming property;
converting the direction of forming an image, based on said predicting step; and
executing the image forming operation.

16. An image forming method as set forth in claim 15 further comprising:
analyzing a layout information based on the pixel information, and further determining whether an area of the image to be formed, is text or photograph.

17. A image forming method as set forth in claim 16
wherein the image forming property includes a joint position information of the line head unit and said predicting step further predicts the direction based on the joint position information so that the jointing position which causes the biggest color unevenness is not crossing over the area to be formed as photograph.

18. An image forming method as set forth in claim 16:
wherein the pixel information includes chromaticity distribution of the image to be formed, and said converting step further converts the direction so that the jointing position which causes the biggest color unevenness crosses over an area which has less chromaticity distribution.

19. An image forming method as set forth in claim 18:
wherein said converting step converts the direction based on color discrimination capability regarding chromaticity and peripheral chromaticity

20. An image forming method as set forth in claim 15 further comprising:
executing an image forming order from an external device.
